(19) United States
(12) Patent Application Publication
(10) Pub. No.: US 2025/0010827 A1
(43) Pub. Date: Jan. 9, 2025

(54) TRAILER CONTROL MODULE WITH TRACTOR PROTECTION FUNCTION

(71) Applicant: ZF CV Systems Europe BV, Brussels (BE)

(72) Inventors: Lukasz Drelich, Wroclaw (PL); Damian Kacki, Wroclaw (PL); Rafal Wardega, Wroclaw (PL); Pawel Swiatek, Wroclaw (PL); Krzysztof Szyszka, Wroclaw (PL)

(21) Appl. No.: 18/761,790

(22) Filed: Jul. 2, 2024

Related U.S. Application Data
(63) Continuation-in-part of application No. 18/218,194, filed on Jul. 5, 2023.

(51) Int. Cl. B60T 13/26; B60T 13/68

(52) U.S. Cl. CPC B60T 13/263; B60T 13/683

(57) ABSTRACT

An electropneumatic trailer control module (100) with a housing structure (100a) includes a manual brake pressure port (154) receiving a driver's brake demand pressure component, a spring-supported electropneumatic input valve (104) with at least two ports and being capable of switching between two positions (open or closed), and an electropneumatic brake pressure port (144; 146) for receiving an electropneumatic brake pressure component from at least one independent pressure source (138; 140), and a relay valve (112) having a control port (110), a supply port (114), an outlet port (116), and a relief port (118). The spring-supported electropneumatic input valve (104) is retained in an open position when there is no electronic activation of the spring-supported electropneumatic input valve (104).

### CROSS-REFERENCE TO RELATED APPLICATIONS

This application is a Continuation-in-Part of U.S. patent application Ser. No. 18/218,194, filed Jul. 5, 2023, the entire content of which is hereby incorporated by reference in its entirety.

### FIELD

The present disclosure relates in general to a trailer control module. More specifically, the trailer control module of the present disclosure includes a tractor protection function within a housing structure of the trailer control module. Such trailer control modules, despite being connected to brake systems of a trailer, are still present at a towing vehicle or tractor part of a tractor-trailer combination vehicle.

### BACKGROUND

Tractor protection valves are known in the art (see, e.g., US granted U.S. Pat. No. 8,297,713 B2). Despite the existence of numerous alternative solutions in the market, there is still a further need to improve the requirements such as reduced components, improved response time and such in relation to enabling the tractor protection function by using the trailer control module.

### SUMMARY OF THE PRESENT DISCLOSURE

In an embodiment, the present disclosure relates to an electropneumatic trailer control module for a pneumatic brake system. The electropneumatic trailer control module comprises a housing structure, a manual brake pressure port receiving driver's brake demand pressure component, an electropneumatic brake pressure port for receiving an electropneumatic brake pressure component from at least one independent pressure source, a relay valve comprising a control port, a supply port, an outlet port, and a relief port, wherein the control port receives at least one of the driver's brake demand pressure and the electropneumatic brake pressure from either directly or indirectly from the manual brake pressure port or the electropneumatic brake pressure port and enables a fluid connection between the supply port and the outlet port in an activated state, wherein the relay valve connects the outlet port to the relief port when the relay valve is in an inactivated state and/or when there is no control pressure at the control port. The electropneumatic trailer control module further comprises a spring-supported electropneumatic input valve with at least two ports and being capable of switching between two positions (open or closed), wherein the spring-supported electropneumatic input valve is retained in an open position when there is no electronic activation of the spring-supported electropneumatic input valve, and wherein the spring-supported electropneumatic input valve is connected to the manual brake pressure port for receiving the driver's brake demand pressure component, and a tractor protection module provided within the housing structure of the electropneumatic trailer control module.

The technical purpose of providing the tractor protection module is to prevent drop in the pressure connections that lead to the trailer, under certain circumstances such as when there is a pressure drop because of a breakage at the lines leading to the trailer. Yet, the tractor protection module is not responsible for the trailer braking in case of breakage at the lines, but only when the breakage occurs at a coupling head will the trailer apply brakes automatically. It should be noted that the brakes of the trailer area applied by a trailer brake system that is separate from the towing vehicle's brake system. Moreover, if the breakage occurs at another coupling head, the trailer braking is not automatically performed. If, as a result, the pressure at the control port of the tractor protection module gets reduced to a certain level, then the tractor protection module will move to a closed state to prevent air loss. Further, it is one of the legal requirements in certain jurisdictions that the tractor protection modules should operate automatically when the air pressure on the towing vehicle is between 138 kPa and 310 kPa or 20 psi and 45 psi or approximately between 1.38 bar and 3.1 bar.

It is of particular advantage that the electropneumatic trailer control module of the present disclosure, by including the tractor protection module within the housing structure, said legal requirements are not only fulfilled by the trailer control module, but further additional lines and connectors when the tractor protection module is provided in a different unit in relation to the trailer control module, as may be the case in some prior art devices, are avoided. For a mass manufacturer such as the Applicant/Patentee of the present disclosure, such cost savings magnify depending on the volume of the manufactured product and/or its associated brake system.

In accordance with the above-mentioned embodiment and as further development, the tractor protection module is positioned in a fluid path established between a connecting line leading from the outlet port of the relay valve and a control pressure coupling head. Thus, by using a single component or sub-valve unit i.e., electropneumatic trailer control module, not only the supply and control pressure transmission to the trailer brakes can be controlled, but also the function of preventing unnecessary leakage at e.g., at the control pressure coupling head is fulfilled. This of particular importance when there is a breakage is found at the line leading from e.g., the control pressure coupling head.

In accordance with one or more of the above-mentioned embodiments and/or in conjunction with a further development, the electropneumatic trailer control module further comprises a select-high valve, wherein the select-high valve or double check valve is configured to receive the pressure from two independent pressure sources and provide an output pressure component which is one of the two independent pressure sources and which has a higher magnitude of pressure in comparison to the other. It is of particular advantage that said select-high valve is provided within the housing structure of the electropneumatic trailer control module. Consequently, providing the supply of brake pressure from at least one source is guaranteed when, for instance, one of the pressure sources is facing a circuit failure or is incapable of supplying the pressurized fluid to electropneumatic trailer control module. Naturally, this improves not only safety aspects associated with electropneumatic trailer control module (i.e., by providing a redundant pressure supply) but also complement the safety of the entire brake circuit in which electropneumatic trailer control module is used.

In accordance with one or more of the above-mentioned embodiments, the output pressure component is connected to the supply port of the relay valve and, at the same time, forms the electropneumatic brake pressure component that reaches the electropneumatic brake pressure port. This simplifies the pressurized fluid connections within the electropneumatic trailer control module of providing the pressure component of same magnitude as both the control pressure and the supply pressure to the relay valve.

In accordance with one or more embodiments of the present disclosure, the electropneumatic trailer control module further comprises an electropneumatic brake pressure inlet valve that is electronically controlled and spring-supported, and wherein the electropneumatic brake pressure inlet valve includes two ports and switches between two positions (open or closed) and assumes a closed position as a default position. For instance, the electropneumatic brake pressure inlet valve as configured in the present explanation with the present position serves two purposes. Firstly, the manual brake pressure component received at the control port of the relay valve is the only pressure component that can reach the control port of the relay valve when the default position of the electropneumatic brake pressure inlet valve is closed and/or when there is, for instance, an electronic failure in the system such that the electropneumatic brake pressure inlet valve cannot be activated. Secondly, it provides the opportunity to control the pressure reaching the control port of the relay valve in a finer manner such as by quick activation and de-activation of the coil associated with the electropneumatic brake pressure inlet valve in which way anti-lock or anti-slip or electronic brake methods can be implemented seamlessly.

In accordance with the same or another embodiment of the present disclosure, the electropneumatic trailer control module further comprises an exhaust solenoid valve that is electronically controlled and spring-supported, wherein the exhaust solenoid valve includes two ports and switches between two positions (open or closed), and assumes a closed position as a default position, and wherein the exhaust solenoid valve connects the pressure component at the control port of the relay valve to an exhaust or relief port when the exhaust solenoid valve is in an open position or is electronically energized. Such an arrangement of the exhaust solenoid valve serves two purposes. Firstly, by being closed in the default position, the pressurized fluid or air present at the control port of the relay valve is not loosely released to the exhaust. For instance, if there is any electronic failure in the device, the exhaust solenoid valve is held in its closed position and hence, the manual brake pressure reaching the control port of the relay valve is not accidentally exhausted. Secondly, even when the brake pressure is applied, for instance, via the electronic control of the electropneumatic inlet valve or if the manual brake pressure reaches the control port of the relay valve, the exhaust solenoid valve can simply be opened by electronic activation to release any residual air at the control port of the relay valve to release the applied brakes. Thus, again, a finer control may be enabled by the operation of the exhaust solenoid valve when the electronic system is indeed intact.

In accordance with one or more of the above embodiments, the tractor protection module is configured to connect the fluid path leading to the control pressure coupling head or C1 with an exhaust path when in a deactivated or closed state and to connect the outlet port of the relay valve to the control pressure coupling head or C1 when in an activated or open state. By providing a simple valve arrangement at the outlet port of the relay valve, the brake fluid connection to the outside of the tractor or towing vehicle is interrupted at the control pressure coupling head. Further, in comparison to the conventional tractor protection modules currently available in the market, which are generally present firstly outside the housing of the electropneumatic trailer control module, the control pressure coupling head can be connected to the exhaust with a flick of the position. In the conventional tractor protectional modules generally only two positions (open or close) are enabled as in a typical 2 port/2 position-valve for selective providing the control pressure at the control pressure coupling head, with no connection to exhaust leading from the control pressure coupling head. Yet another significance of the configuration of enabling a connection of the fluid path leading from the control pressure coupling head or C1 to the exhaust path is—when a driver parks the tractor with the trailer attached to it, and thereafter applies the dash valve but at the same time activates the service brake (i.e., at the foot brake valve), then the biased spring present at the tractor protection module moves the position of the tractor protection module such the control pressure coupling head at C1 will be exhausted (see e.g., FIG. 1 where this position is shown). This causes the exhaust or relief of lines connected e.g., at reference numerals “132” and “C2” (c.f. FIG. 1). Such a technical advantage of the present disclosure is not possible in other market solutions.

In accordance with one or more of the above embodiments, the tractor protection module comprises a tractor protection control port for receiving trailer brake pressure via a trailer brake pressure port.

In an advantageous embodiment, the tractor protection module is a spring-supported pneumatically operated valve. For instance, the provision of the spring support in the tractor protection module helps in retaining the tractor protection module at a default position, which is the deactivated state and to move to an activated or open state only when there is control pressure received at the control pressure port of the tractor protection module.

In accordance with a preferred embodiment, the tractor protection module includes a control chamber for receiving the control pressure from the tractor protection control port, a piston configured to linearly reciprocate on receiving the control pressure, an intermediate supply chamber connected to the outlet port of the relay valve, and an outlet chamber connected to an outlet line, wherein the outlet line leads to the control pressure coupling head (C1), and wherein, when the control chamber receives the control pressure from the tractor protection control port, the piston is configured to linearly reciprocate such that a fluid connection between the intermediate supply chamber and the outlet chamber is established so that the pressurized fluid can reach the control pressure coupling head (C1).

In accordance with the above-explained embodiment or in conjunction with one or more preferred embodiments of the present disclosure, the tractor protection module further comprises a spring to bias the piston into a closed position such that, without the control pressure at the control chamber, no fluid connection between the intermediate supply chamber and the outlet chamber can be or is allowed to be established. As also explained above, this provision of the spring to keep the piston into the closed position in the tractor protection module helps in retaining the tractor protection module at a default position and contributes to functional safety of the tractor protection module.

In accordance with one or more embodiments discussed above, the tractor protection module further includes a sealing element associated with the piston to sealingly separate the intermediate supply chamber from the outlet chamber, when there is no control pressure received at the control chamber. Thus, the provision is given, whereby when the control pressure is indeed received at the control chamber, the spring is compressed and the connection between the intermediate supply chamber and the outlet chamber is established and in that, the sealing element ensures there is no leakage of the pressurized fluid from the intermediate supply chamber to the outlet chamber and vice versa.

In conjunction with one or more embodiments discussed above, the tractor protection module further comprises at least one tubular support member for aligning the piston in a linear position and/or for preventing any misalignment of the piston in relation to the orientation of the tractor protection module. The tubular support member not only aligns the piston but also ensures the repeatability of the movement of the piston in the same aligned direction when the piston reciprocates.

In a yet another exemplary embodiment of the present disclosure, the tractor protection module is designed either as a pneumatically operated valve with three ports and one control port and capable of being switched into two positions (open or closed). Either of the designs may provide the requisite functional conditions satisfied, which are expected out of the tractor protection module. For instance, spatial arrangements of the other elements within the housing structure of the electropneumatic trailer control module may dictate the choice of the design of the tractor protection module, in accordance with one particular example.

In accordance with any one of the embodiments described above dealing with the tractor protection module, the piston includes a first slot comprising a sealing element for fluidically separating the outlet chamber from an exhaust or relief port when there is pressure in the control port and/or the control chamber. Alternatively, in the electropneumatic trailer control module, the tubular support includes a slot comprising a sealing element for fluidically separating the outlet chamber from an exhaust or relief port when there is pressure in the control port and/or the control chamber.

In one or more of the above embodiments, the piston of the tractor protection module includes at least one leaking feature to enable flow of pressurized fluid from the outlet chamber towards an exhaust or relief port when there is no pressure received in the control chamber. The technical purpose is that, when there is no pressure in the control chamber of the tractor protection module, the spring holds the piston in a stable position due to its extension force. At this stage, a gap region (for instance, marked with reference 204b in FIG. 2) exists between the piston and the tubular support member through which a fluid connection is established between the outlet chamber and the exhaust or relief port because the at least one leaking feature at least approximately axially coincides with the gap region. This enables the fluid from the outlet chamber to reach the relief port. More explanation in conjunction with the figures will be provided in the detailed description of the present disclosure below.

In a particularly advantageous embodiment, the spring-supported electropneumatic input valve includes two ports, for example an input port and an output port, and is configured to change between only two positions (open and closed), wherein the output port is connected to the control port of the relay valve. The usage of the spring-supported electropneumatic input valve with two ports and two positions not only simplifies the construction of the electropneumatic trailer control module, but also reduces response time that is needed to implement the instructions of an electronic connection relative to other kinds of input valves having a higher number of ports and with the attainment of the same number of positions. Also, the electronic connection may receive signals or instructions from an external electronic control unit (ECU).

In accordance with one or more of the above-mentioned embodiments, the tubular support member further comprises a leaking feature in the form a gap, wherein the gap enables connection between the existing space established between the piston and the tubular support member below the level of the gap and another chamber. In a particularly advantageous embodiment, the gap is in the form of at least one slot provided at the tubular support member so that the fluid connection between the existing space can be established between the piston and the tubular support member below the horizontal level of the gap and another chamber.

Other particular advantages of various embodiments of the present disclosure can be derived from the detailed description and the drawings of the present disclosure. Claims may be used along with the summary, description, and drawings for determining the scope of the present disclosure.

### BRIEF DESCRIPTION OF THE DRAWINGS

FIG. 1 illustrates a schematic view of an electropneumatic trailer control module in accordance with the present disclosure;

FIG. 2 illustrates a vertical cross-sectional view of a tractor protection module, which is part of the electropneumatic trailer control module of a first embodiment of the present disclosure;

FIG. 3 illustrates a horizontal cross-sectional view of the tractor protection module of FIG. 2 at a plane A1-A2; and

FIG. 4 illustrates a vertical cross-sectional view of another tractor protection module, which is part of the electropneumatic trailer control module, according to a second embodiment of the present disclosure.

### DETAILED DESCRIPTION

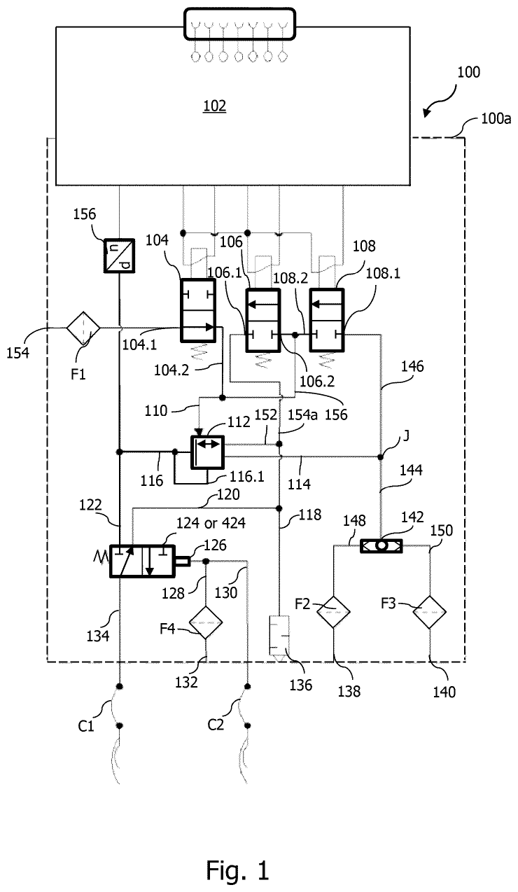

FIG. 1 illustrates a schematic view of an electropneumatic trailer control module 100 in accordance with a first embodiment of the present disclosure. In accordance with the present disclosure, electropneumatic trailer control module 100 comprises a housing structure 100a.

Electropneumatic trailer control module 100 comprises a manual brake pressure port 154 receiving a driver's brake demand pressure component, a spring-supported electropneumatic input valve 104 with at least two ports and being capable of switching between two positions (open or closed), wherein the spring-supported electropneumatic input valve 104 is retained in an open position when there is no electronic activation of spring-supported electropneumatic input valve 104 takes place, and wherein spring-supported electropneumatic input valve 104 is connected to manual brake pressure port 154 for receiving the driver's brake demand pressure component. Electropneumatic trailer control module 100 further comprises an electropneumatic brake pressure port 144 or 146 for receiving an electropneumatic brake pressure component from at least one independent pressure source 138 or 140. Electropneumatic trailer control module 100 still further comprises a relay valve 112 comprising a control port 110, a supply port 114, an outlet port 116, and a relief port 118, wherein the control port 110 receives at least one of the driver's brake demand pressure component and the electropneumatic brake pressure component and enables a fluid connection between the supply port 114 and the outlet port 116 in an activated state, and wherein the relay valve 112 connects the outlet port 116 to the relief port 118 when the relay valve 112 is in an inactivated state and/or when there is no control pressure at the control port 110. The electropneumatic trailer control module 100 further comprises a tractor protection module 124 provided within housing structure 100a of the electropneumatic trailer control module 100.

The technical purpose of providing the tractor protection module 124 is to prevent a drop in the pressure connections that lead to the trailer, under certain circumstances such as when there is a pressure drop because of a breakage at the lines leading to the trailer (not shown in the Figures). Tractor protection module 124 is not responsible for the trailer braking in case of breakage at the lines, and only when the breakage occurs at a coupling head C2 of FIG. 1 will the trailer apply brakes automatically. It should be noted that the brakes of the trailer are applied by a trailer brake system that is separate from the towing vehicle's brake system. Moreover, if the breakage occurs at another coupling head, such as C1 of FIG. 1, the trailer braking is not automatically performed. If, as a result, the pressure at port 126 is reduced to a certain level, tractor protection module 124 will move to a closed state to prevent air loss.

Further, it is one of the legal requirements in certain jurisdictions that tractor protection modules should operate automatically when the air pressure on the towing vehicle is between 138 kPa and 310 kPa or 20 psi and 45 psi or approximately between 1.38 bar and 3.1 bar. It is of particular advantage that electropneumatic trailer control module 100 of the present disclosure, by including tractor protection module 124 within housing structure 100a, fulfills these legal requirements without requiring additional lines and connectors along with a separate valve, as is the case in some prior art devices in which the tractor protection module is provided outside the trailer control valves or their respective housings.

Moreover, in a particularly advantageous embodiment, spring-supported electropneumatic input valve 104 includes two ports 104.1, 104.2 i.e., an input port 104.1 and an output port 104.2, wherein output port 104.2 is connected to control port 110 of relay valve 112. In one aspect, only valve 104 includes only these ports. The usage of spring-supported electropneumatic input valve 104 with two ports and two positions not only simplifies the construction of electropneumatic trailer control module 100, but also reduces response time that is needed to implement the instructions of an electronic connection 102 relative to other kinds of input valves with such as higher number of ports and with the attainment of same number of positions. For instance, electronic connection 102 may receive signals or instructions from an external electronic control unit (ECU).

Further, tractor protection module 124 is positioned in a fluid path established between a connecting line leading from outlet port 116 of relay valve 112 and a control pressure coupling head C1. As can be seen from FIG. 1, outlet port 116 leads to coupling head C1, which is directed to provide control pressure to the trailer attached to the towing vehicle. In comparison to what is already known, port 116 and a connecting line leading from port 116 towards coupling head C1 are provided within housing structure 100a and more importantly, it is in said connecting line tractor protection module 124 is provided. Thus, by using a single component i.e., electropneumatic trailer control module 100, not only the supply and control pressure transmission to the trailer brakes can be controlled, but also the function of preventing unnecessary leakage at e.g., coupling head C1 is fulfilled.

Furthermore, electropneumatic trailer control module 100 further comprises a select-high valve 142, wherein the select-high valve or double check valve 142 is configured to receive supply pressure from two independent pressure sources 138 and 140 and provide an output pressure component which is one of two independent pressure sources 138, 140 and which has a higher magnitude of pressure in comparison to the other. Consequently, providing the supply of brake pressure from at least one source is guaranteed when, for instance, one of the pressure sources is facing a circuit failure or is incapable of supplying the pressurized fluid to electropneumatic trailer control module 100. Naturally, this improves not only safety aspects associated with electropneumatic trailer control module 100 but also of the entire brake circuit in which electropneumatic trailer control module 100 is used.

It follows from the above, it can also be inferred from FIG. 1 that the output pressure component is connected to supply port 114 of relay valve 112 and, at the same time, forms the electropneumatic brake pressure component that reaches electropneumatic brake pressure port 144 and/or 146. From FIG. 1, at junction “J”, once select-high valve 142 transmits the output pressure component, which is one of the pressurized fluid sources from two independent pressure sources 138 and 140, the same pressure component is used as the supply pressure for relay valve 112 as well as at least valve 108 so that arrival of the control pressure at control port 110 is assured because at least two independent pressure sources 138 and 140 (in addition to the pressure received at manual brake pressure port 154) are involved in providing the control pressure.

Electropneumatic trailer control module 100 further comprises an electropneumatic brake pressure inlet valve 108 that is electronically controlled and spring-supported, and wherein electropneumatic brake pressure inlet valve 108 includes two ports 108.1, 108.2 and switches between two positions (open or closed), and assumes a closed position as a default position. By providing a spring-supported electropneumatic brake pressure inlet valve 108 which assumes defaulted closed position, the connection between electropneumatic brake pressure port 146 and control port 110 of relay valve 112 via line 156 is only allowed if there is an electrical/electronic activation of valve 108. In the absence of any electronic activation or in the absence of any excitation current reaching electropneumatic brake pressure inlet valve 108, it is anyway possible to supply the control pressure from manual brake pressure port 154, which is directly or indirectly connected to a foot brake valve or a brake signal transmitter that is operable via a foot pedal. Further details regarding the working of valve 108 will be apparent in view of the explanation provided regarding the general working of electropneumatic trailer control module 100 below.

It follows from the above, that electropneumatic trailer control module 100 still further comprises an exhaust solenoid valve 106 that is electronically controlled and spring-supported, wherein exhaust solenoid valve 106 includes two ports 106.1, 106.2 and switches between two positions (open or closed), and assumes a closed position as a default position, and wherein exhaust solenoid valve 106 connects the pressure component at control port 110 of relay valve 112 to an exhaust or relief port 136 when exhaust solenoid valve 106 is in an open position or is electronically energized. By providing exhaust solenoid valve 106 at line 156 connecting, inter alia, control port 110 of relay valve 112, exhaust solenoid valve 106 provides the possibility of relieving any residual pressure existing in control port 110 of relay valve 112 to atmosphere. Typically, when executing a modulated control of application and release of brakes, such exhaust solenoid valve 106 can facilitate application and/or relief of pressure from respective wheel end actuators, in particular by establishing fluid connection between control port 110 of relay valve 112 and relief port 136.

Further, tractor protection module 124 is configured to connect the fluid path leading to control pressure coupling head C1 with exhaust when in a deactivated or closed state and to connect outlet port 116 of relay valve 112 to control pressure coupling head C1 when in an activated or open state. For instance, such a configuration of tractor protection module 124 enables a function such that any residual pressure in the line leading to control pressure coupling head C1 is relieved through relief port 136 as can be taken, e.g., from FIG. 1.

In accordance with one or more embodiments of the present disclosure, tractor protection module 124 comprises a tractor protection control port 126 for receiving trailer supply pressure via a trailer supply pressure port 132. Such trailer supply pressure port 132 is connected, for instance, to a dash valve (not shown in the Figures) provided at the driver's cabin. This port 132, thus, provides a direct control to apply trailer brakes. Furthermore, in accordance with an exemplary implementation, said dash valve is provided with two buttons including a push button and a pull button. Each of the buttons are assigned a function as in whether the trailer brakes need to be applied or at least one of the lines connecting or leading to control and/or supply coupling heads C1 and C2 be exhausted via the relief port such as “136” shown in FIG. 1. For instance, by providing trailer brake pressure port 132, in case of break away situation at coupling heads C1 and/or C2, the driver can simply provide a control pressure or withdraw the control pressure at port 126 such that unnecessary leakage of pressurized fluid could be prevented and/or stopped on the basis of driver's intervention.

In accordance with one or more embodiments of the present disclosure, tractor protection module 124 is a spring-supported pneumatically operated valve. By using the spring, tractor protection module 124 can return to its default position, when there is no control pressure at port 126 of tractor protection module 124.

The general working of electropneumatic trailer control module 100 will be explained in the following passages.

As can be taken from FIG. 1, electropneumatic trailer control module 100 is configured to receive a driver's brake demand via manual brake pressure port 154, in accordance with a first scenario. As the pressurized air enters port 154, it filtered for impurities by a first filter F1 before it reaches spring-supported electropneumatic input valve 104. As also mentioned above, spring-supported electropneumatic input valve 104 has at least two ports i.e., an input port 104.1 and an output port 104.2 and is capable of switching between two positions (open or closed). Furthermore, the spring-supported electropneumatic input valve 104 is retained in an open position when there is no electronic activation of spring-supported electropneumatic input valve 104 taking place. This position of being open is a default position for the spring-supported electropneumatic input valve 104 and is configured so as to ensure that the reception of the driver's brake demand is available for the activation of relay valve 112.

In any case, once the brake pressure reflecting the driver's brake demand passes through the filter, it flows through spring-supported electropneumatic input valve 104 i.e., ports 104.1 and 104.2 and reaches control port 110 of relay valve 112. The brake pressure at control port 110 of relay valve 112 fills up a control chamber (not shown) of relay valve 112 and activates a piston (not shown) with a longitudinally extending plunger (not shown). As the piston of relay valve 112 is activated, a connection between supply port 114 of relay valve 112 and outlet port 116 is established.

Alternative to the above-described first scenario, when there is no driver's brake demand pressure at manual brake pressure port 154, it should still be possible to activate relay valve 112, by sending control pressure via control port 110. In this scenario, as can be taken from FIG. 1, ports 138 and 140 receive pressurized fluid from two independent sources of the pressurized fluid, which are not shown in the figures. These two independent sources of the pressurized fluid can be, for instance, two different fluid or air reservoirs. In any case, as the pressurized fluid from the two independent sources enter ports 138 and 140, the pressurized fluid from the respective ports are filtered by a second filter F2 and a third filter F3. Thereafter, the pressurized fluid reach connecting lines 148 and 150 as they are at least fluidically connected to ports 138 and 140. At this juncture, select-high valve 142 is disposed including two input ports connected to lines 148 and 150 and one output port connected to line 144 (see FIG. 1).

In accordance with the implementation illustrated in FIG. 1, select-high valve 142 is implemented as a double check valve. Select-high valve 142 is configured to receive brake pressure from said two independent pressure sources via ports 138, 140 and provide an output pressure component which is one of the two independent pressure sources 138, 140 and which has a higher magnitude of pressure in comparison to the other.

As the output pressure component from select-high valve 142 reaches junction “J” in FIG. 1, the output pressure component is connected with input or supply port 114 of relay valve 112 as well as with inlet port 108.1 of electropneumatic brake pressure inlet valve 108. Electropneumatic brake pressure inlet valve 108 is normally in a closed position or alternatively put, valve 108 takes a closed position as its default position. When electronic connection 102 provides a signal for activating valve 108, a fluid connection between its inlet port 108.1 and outlet port 108.2 is established thereby transmitting control pressure for activating relay valve 112 through its control port 110. Thus, even when there is no control pressure received via manual brake pressure port 154, electronic connection 102 can control application of the trailer brakes taking the electropneumatic brake pressure component from two independent pressure sources 138 and 140.

If the control pressure taking the electropneumatic brake pressure component should be stopped from reaching control port 110 of relay valve 112 or if relay valve 112 should be prevented from activation, electronic connection 102 shifts the position of electropneumatic brake pressure inlet valve 108 into to the closed position, whereby the fluid connection between ports 108.1 and 108.2 is stopped or hindered (see FIG. 1). At the same time, electronic connection 102 operates exhaust solenoid valve 106 into an open position that is not only electronically controlled, but also is supported by a spring. This means exhaust solenoid valve 106 can be biased into a default position when there is no signal from electronic connection 102. As can be taken from FIG. 1, exhaust solenoid valve 106 includes two ports i.e., inlet port 106.1 and outlet port 106.2 and switches between two positions (open or closed), and assumes a closed position as a default position due to e.g., biased force exerted by the spring. Furthermore, exhaust solenoid valve 106 connects the pressure component at control port 110 of relay valve 112 to exhaust or relief port 136 when exhaust solenoid valve 106 is in an open position or is electronically energized. From FIG. 1, it can be seen that exhaust solenoid valve 106 is in a closed position i.e., no fluid connection between ports 106.1 and 106.2 is established. However, when electronic connection 102 activates exhaust solenoid valve 106 into the open position and at the same time moves electropneumatic brake pressure inlet valve 108 into the closed position, control port 110 of relay valve 112 is connected to relief port 136. By this way, electronic connection 102 can execute modulated operation of applying and disengaging the trailer brakes.

In any case, in both the above-mentioned scenarios, i.e., the manual brake pressure component received via port 154 and the electropneumatic brake pressure component received via line 144 or 146 (or two independent pressure sources 138 and 140) ensure at least there is a possibility of establishing a fluid connection between supply port 114 and outlet port 116 of relay valve 112. This is made possible by providing the control pressure through the presence of the control pressure at control port 110 or relay valve 112 either from valve 104 (with the manual brake pressure component) or from valve 108 (with the electropneumatic brake pressure component).

Moving on to tractor protection module 124, which receives the output pressure via outlet port 116 of relay valve 112, it is configured to operate in two positions. Tractor protection module 124, as shown in FIG. 1, includes tractor protection control port 126. Tractor protection control port 126 receives the control pressure to change the position via trailer supply pressure port 132. As mentioned above, trailer supply pressure port 132 is connected to a dash valve (not shown in the figures) provided at the driver's dash board. When the trailer brakes need to be engaged, a pull-push button needs to be activated by the driver of the vehicle. This enables a connection between a pressurized fluid source to port 126 as well as supply coupling head C2. A fourth filter F4 is provided at line 128 that connects ports 126 and 132.

Once the control pressure reaches port 126, tractor protection module 124 shifts its position from the current disengaged state to an engaged state. Note that in the disengaged state, as displayed in FIG. 1, not only are lines 122 and 134 which lead from outlet port 116 of relay valve 112 towards control coupling head C1 disconnected, but also line 134 leading to control coupling head C1 is redirected to relief port 136. By this way, any residual pressure present in line 134 leading to control coupling head C1 is exhausted. Moreover, in a breakaway situation where the trailer brake lines leading from coupling heads C1 and C2 are disconnected for whatever reason, such a failure results in a drop in the pressure at lines 128 and 130. Consequently, if tractor protection module 124 prior to breakaway situation was in an engaged state, will move to the disengaged state as shown in FIG. 1.

As can be noticed from FIG. 1, tractor protection module 124 is spring-supported. Thus, tractor protection module 124 is configured to retain the closed or disengaged position that is shown in FIG. 1 when there is no control pressure. However, when the magnitude of control pressure at port 126 is within a predetermined range such as the one prescribed sub-paragraphs (a) and (b) of section 393 under Title 49 of Federal Motor Carrier Safety Administration (FMCSA), tractor protection module 124 should automatically operate to apply e.g., trailer brakes i.e., shift from the disengaged position as shown in FIG. 1 to an engaged position where connection between lines 122 and 134. Said predetermined pressure range is defined as a range that could not be lower than 20 pounds per square inch (PSI) nor higher than 45 pounds per square inch (PSI) or not lower than approximately 1.38 bar and not higher than 3.1 bar of pressure.

Additionally, if the driver intends to initiate the trailer brakes manually, the dash valve provided in the driver's cabin should be able to send the control pressure via port 132 to port 126 of tractor protection module 124 in order to engage the trailer brakes. Such a situation can occur, for instance, when the driver is notified of pressure drop in the brake circuit of the towing vehicle due to any equipment failure, he or she should be able to apply the trailer brakes along with the towing vehicle brakes. Furthermore, as per, for instance, sub-paragraph (a) of section 393 under title 49 of FMCSA, a mechanism for providing that in the case of a breakaway of the trailer, the service brakes on the towing vehicle will be capable of stopping the towing vehicle.

By providing tractor protection module 124 as part of or within housing structure 100a of electropneumatic trailer control module 100, more expensive and/or complicated solutions such as providing a separate tractor protection valve is avoided. Combined with spring-supported 2 ports/2 positions electropneumatic input valve 104 and tractor protection module 124, the response time of electropneumatic trailer control valve 100 for engaging the service brakes of the trailer is reduced.

Furthermore, as shown in FIG. 1, electropneumatic trailer control valve 100 with a combination of the pressure sources including the driver's brake demand via port 154 in conjunction with spring-supported electropneumatic input valve 104, and two independent pressure sources 138 and 140 in conjunction with electropneumatic brake pressure inlet valve 108 provides at least two different possibilities of the service brake command (manual or electronic) to reach relay valve 112. Thus, electropneumatic trailer control valve 100 is configured such that the trailer brakes can be timely applied not only when there is an emergency situation of the “breakaway”, but also to automatically operate when the air pressure within the towing vehicle brake circuit falls within said predetermined range (see above).

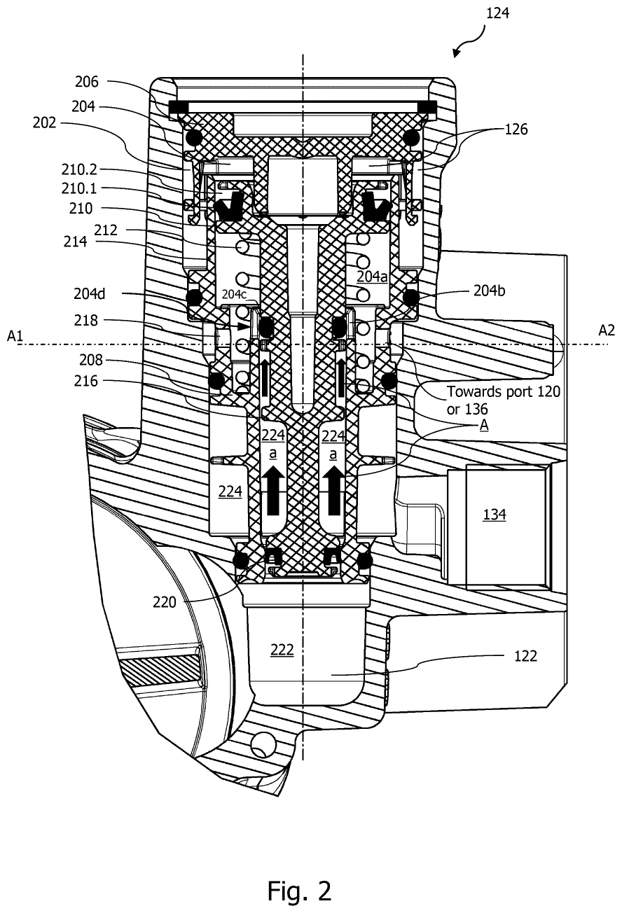

FIG. 2 illustrates a vertical cross-sectional view of tractor protection module 124 of the first embodiment, which is part of electropneumatic trailer control module 100. As can be taken from FIG. 2, tractor protection module 124 is spring-supported by having at least one spring 212 to hold a piston 216 in its default position. The position of respective components of tractor protection module 124 shown in FIG. 2 is in default position or closed position, whereby line 134 leading from control coupling head C1 is connected to exhaust or relief port 136 (c.f. FIG. 1).

In accordance with the present embodiment, tractor protection module 124 includes a control chamber 204 for receiving the control pressure from tractor protection control port 126 (c.f. FIG. 2), which is marked in FIG. 2 to show that there is a fluid connection between port 126 and chamber 204. Tractor protection module further includes piston 216 configured to linearly reciprocate on receiving the control pressure. As shown in FIG. 2, the control pressure via port 126 (which is labelled as a region of tractor protection module 124) is received at a top region of or above piston 216. This region is marked with two distinct portions or chambers 202 and 204, which are connected with each other. In order words, fluid present in chamber 202 can reach chamber 204. And chamber 202 is connected to tractor protection control port 126. In the position displayed in FIG. 2, because there is no pressure received from tractor protection control port 126, piston 216 is held in a spring biased position, or the default position.

Furthermore, tractor protection module 124 further comprises an intermediate supply chamber 222 connected to outlet port 116 of relay valve 112. As can be recognized from FIG. 2, only a partial section of port or line 122 is shown and is present at a bottom portion of tractor protection module 124 taking the orientation displayed in FIG. 2 into account. Still furthermore, an outlet chamber 224 connected to an outlet line 134 is provided as part of tractor protection module 124, wherein outlet line 134 leads to control pressure coupling head C1. What is derivable from FIG. 2 is that a connection can be established between intermediate supply chamber 222 and outlet chamber 224 via at least one recesses 224a provided as part of at least one tubular support member 208. This is the case when for instance piston 216 moves vertically downwards against the biasing force exerted by spring 212 on piston 216. As piston 216 moves downwards, lip seal or a sealing element 220 is unseated and does not make any contact with any internal surface of at least one tubular support member 208 owing to its downward movement. Thus, the pressurized air from intermediate supply chamber 222 reaches recess 224a and consequently, outlet chamber 224 and/or outlet line 134 (which in turn originates from outlet chamber 224 and leads to control coupling head C1 (c.f. FIG. 1)). On a different note, sealing element 220 does not necessarily have to be a lip seal, it can be any kind of sealing rings such as O-ring or Z-ring.

Thus, in summary, when control chamber 204 receives the control pressure from tractor protection control port 126, piston 216 is configured to linearly reciprocate such that a fluid connection between intermediate supply chamber 222 and outlet chamber 224 is established so that the pressurized fluid can reach control pressure coupling head C1.

However, as shown in FIG. 2, no connection between intermediate supply chamber 222 and outlet chamber 224 is established when it is in its default position and no control pressure is received at tractor protection control port 126. Thus, at this position, as shown in FIG. 1, tractor protection module 124 provides a fluid connection between line 134 and relief port 136. As can be seen in FIG. 2, arrow marks “A” show the flow of fluid from line 134 and/or chamber 224 towards another chamber 204a that holds spring 212, wherein said chamber is separated from chamber 204 via a lateral extension 210 of piston 216 and inner walls of tubular support member 208. Furthermore, above lateral extension 210 of piston 216 is a slot 210.2 formed, which is also part of piston 216. At slot 210.2 is provided a piston lip seal 210.1 that forms a fluid-tight seal between piston 216 and inner walls of tubular support member 208. Thus, piston lip seal 210.1 assists in fluid-tight separating of chamber 204 from chamber 204a.

A gap 204b exists between piston 216 and tubular support member 210. Gap 204b enables connection between the existing space established between piston 216 and tubular support member 208 below the level of gap 204b and another chamber 204a. The chamber 204a is however connected to relief port 136 via inter alia channel 218.

On a different note, clear disconnection between chamber 222 and chamber 224, as shown in FIG. 2, is assisted with lip seal 220. Thus, lip seal 220 associated with piston 216 is configured to separate intermediate supply chamber 222 from outlet chamber 224, when there is no control pressure received at the control chamber 204.

And, optionally, at least one tubular support member 208 is provided for aligning piston 216 in a linear position and/or for preventing any misalignment of piston 216 in relation to the orientation of tractor protection module 124.

When there is pressure drop in the towing vehicle brake system below the predetermined range such as the one prescribed sub-paragraphs (a) and (b) of section 393 under Title 49 of FMCSA and/or if there is a breakaway at the coupling heads, tractor protection module 324 needs to automatically operate and thereby, activating emergency features of the braking system associated with the towing vehicle or tractor. Alternatively, if the driver provides control pressure by activating the dash valve(s) provided in the driver's cabin via port 132, and when this control pressure reaches tractor protection control port 126, tractor protection module 124 needs to change its position.

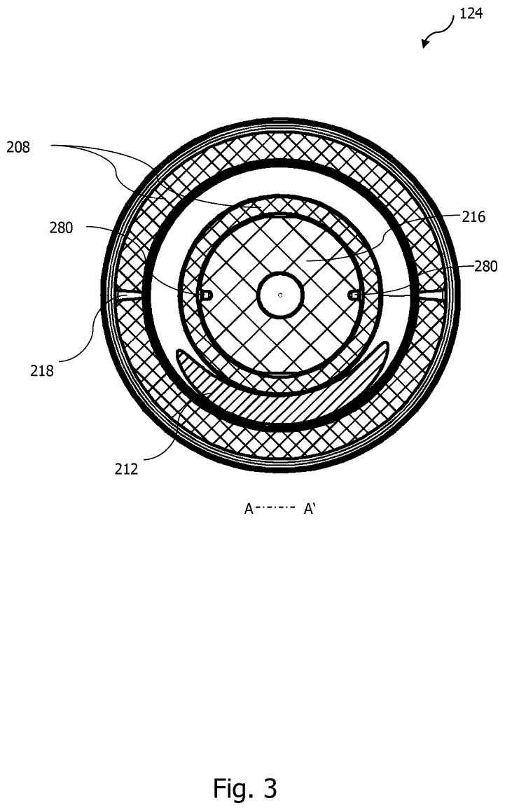

FIG. 3 illustrates a horizontal cross-sectional view of tractor protection module 124 of FIG. 2 at a plane A1-A2. The axial position of the plane A1-A2 can be seen in FIG. 2. At this location, what is more important to recognize is the presence of at least one leaking feature 280 as shown in FIG. 2. There could, of course, be other leaking features, such as small differences in the diameter of piston 216 in comparison to an inner surface of tubular support member 208.

In the present embodiment, piston 216 includes at least one leaking feature in form of an opening 280 to enable flow of pressurized fluid from outlet chamber 224 towards an exhaust or relief port 136 when there is no pressure received in control chamber 204 (to be read in conjunction with FIG. 2 as well). However, once the pressure via port(s) 130 and/or 126 reach control chamber 204, piston 216 moves linearly down along the inner surface of tubular support member 214. As piston 216, sealing element 204c or sealing ring 204c or an O-ring blocks any fluid connection between chambers 224, 224a and 204a. At the same time, connection between intermediate supply chamber 222 and relief port 136 is established. In the same embodiment, tubular support member 208 comprises another leaking feature in the form a gap 204b (see FIG. 2) which exists between piston 216 and tubular support member 210. As mentioned above, gap 204b enables connection between the existing space established between piston 216 and tubular support member 208 below the level of gap 204b and another chamber 204a.

In an alternative embodiment, it is possible that the at least one leaking feature can be provided at the tubular support member 208 rather than piston 216.

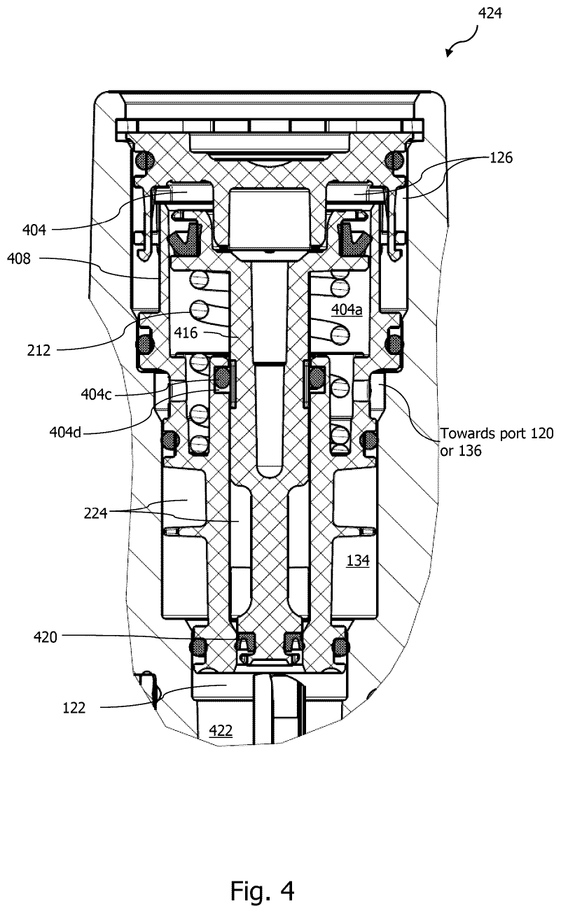

FIG. 4 illustrates a vertical cross-sectional view of another tractor protection module 424 according to an alternative embodiment, which can be part of electropneumatic trailer control module 100.

The primary difference between tractor protection module 124 of FIGS. 2 and 3 and the tractor protection module 424 of FIG. 4 lies in the positioning of sealing element or sealing ring or O-ring 404c at a slot or provision 404d that is provided at tubular support member 408 and not at piston 416. Such a design may provide a technical advantage of preventing a blow off of sealing element 404c due to the pressurized fluid flowing from chamber 424 towards relief port 136 via another chamber 404a and/or any leakage of pressure that may occur because of the blow off of sealing element 404c, when there is no control pressure received at control chamber 404 of the tractor protection module 424.

Another difference lies in the fact that the outer diameter of piston 416 has at least one slot to enable the pressurized fluid to flow through piston 416 to enable connection between chambers 224 and 404a. Yet another alternative solution is to provide piston 416 with a reduced diameter (more on this below) i.e., the diameter of piston 416 is smaller in comparison to the inner diameter of tubular support member 408 at the region below sealing element 404c such that the fluid connection can be established between chambers 224 and 404a when there is no pressure at control chamber 404. On the other hand, when there is pressure in control chamber 404, piston 416 moves linearly down with a region above sealing element 404c having a larger diameter leaves no gap between the outer diameter of piston 416 and inner diameter of tubular member 408. Consequently, the pressure air from port 122 reaching intermediate supply chamber 422 is transferred to port 134 in an air-tight manner.

The general functioning of traction module 424 is the same or similar to tractor protection module 124 of FIGS. 2 and 3, except for the above-explained differences. Thus, for the sake of brevity, the functioning principle explained above, in relation to FIGS. 2 and 3 is not repeated.

The scope of the present disclosure is defined via one or more claims that are provided in the following sections. However, the summary, drawings, and the accompanying description may be used for interpretation purposes of various features of the appended claims.

### LIST OF REFERENCE SIGNS (PART OF THE DESCRIPTION)

100—electropneumatic trailer control module
100a—housing structure
102—an electronic connection
104—spring-supported electropneumatic input valve
104.1—input port of spring-supported electropneumatic input valve 104
104.2—output port of spring-supported electropneumatic input valve 104
106—exhaust solenoid valve
106.1—input port of exhaust solenoid valve 106
106.2—output port of exhaust solenoid valve 106
108—electropneumatic brake pressure inlet valve
108.1—inlet port of electropneumatic brake pressure inlet valve 108
108.2—outlet port of electropneumatic brake pressure inlet valve 108
110—control port of relay valve 112
112—relay valve
114—supply port of relay valve 112
116—outlet port of relay valve 112
116.1—a pilot bypass line of relay valve 112 enables connection between outlet port
116 to relay valve 112
118—line leading to a relief port or symbolically represents a relief port itself
120—line connecting tractor protection module 124 with relief port 118
122—line leading from outlet port 116 of relay valve 112 to control coupling head C1 via an inlet chamber of tractor protection module 124 or 424
124—tractor protection module of the first embodiment
126—port receiving control pressure at tractor protection module 124
128—line connecting port 126 and port 132, which is connected to the dash valve (not shown)
130—line connecting supply coupling head C2 and port 126
132—trailer supply pressure port
134—outlet line leading to control pressure coupling head C1
136—exhaust or relief port
138—port receiving pressurized fluid from a first source (e.g., an air reservoir)
140—port receiving pressurized fluid from a second source (e.g., an air reservoir)
142—select-high valve or double check valve
144—electropneumatic brake pressure port reaching supply port or line 114 of relay valve 112 and/or reaching electropneumatic brake pressure inlet valve 108
146—line transmitting electropneumatic brake pressure component reaching electropneumatic brake pressure inlet valve 108
148—line connected to port 138 receiving pressurized fluid from the first source
150—line connected to port 140 receiving pressurized fluid from the second source
152—line connecting relay valve 112 with relief port 136 or with 118
154—a manual brake pressure port
154a—line connecting exhaust solenoid valve 106 with relief port 136 or with 118
156—line connecting, inter alia, control port 110 of relay valve 112 and exhaust solenoid valve 106 and electropneumatic brake pressure inlet valve 108, it provides the possibility of relieving any pressure existing any pressure existing in control port 110 of relay valve 112 to atmosphere while at the same time providing the possibility of connecting control port 110 of relay valve 112 with pressure from valve 108
F1—a first filter at manual brake pressure port 154
F2—a second filter at port 138
F3—a third filter at port 140
F4—a fourth filter at manual brake pressure port 154
204—control chamber of tractor protection module 124
204a—another chamber of tractor protection module 124
204b—gap between piston 216 and tubular support member 210
204c—sealing element
204d—slot for receiving sealing element 204c
206—support structure for holding tubular support member 208 and piston 216
208—tubular support member of tractor protection module 124
210—lateral extension of piston 216
210.1—piston lip seal
210.2—slot as part of piston 216
212—spring
214—lower part of tubular support member 208 of tractor protection module 124
216—piston
218—channel that connects another chamber 204a with relief port 136
220—sealing element e.g., a lip seal
222—intermediate supply chamber of tractor protection module 124
224—outlet chamber of tractor protection module 124
224a—a recess 224a formed at tubular support member 208
280—leaking feature in piston 216
404—control chamber of tractor protection module 424
404a—another chamber of tractor protection module 424
404c—sealing element
404d—slot for receiving sealing element 404c
408—tubular support member of tractor protection module 424
420—sealing element or lip seal
422—intermediate supply chamber of tractor protection module 424
424—tractor protection module of the second or alternative embodiment
C1—control coupling head
C2—supply coupling head

1. An electropneumatic trailer control module (100) for a pneumatic brake system, the electropneumatic trailer control module (100) comprising:
a housing structure (100a);
a manual brake pressure port (154) that receives a driver's brake demand pressure component;
an electropneumatic brake pressure port (144; 146) that receives an electropneumatic brake pressure component from at least one independent pressure source (138; 140); and
a relay valve (112) comprising a control port (110), a supply port (114), an outlet port (116), and a relief port (118),
wherein the control port (110) receives at least one of the driver's brake demand pressure component and the electropneumatic brake pressure component either directly or indirectly from the manual brake pressure port (154) or the electropneumatic brake pressure port (144; 146) and enables a fluid connection between the supply port (114) and the outlet port (116) in an activated state, wherein the relay valve (112) connects the outlet port (116) to the relief port (118) when the relay valve (112) is in an inactivated state and/or when there is no control pressure at the control port (110), and
wherein, the electropneumatic trailer control module (100) further comprises:
a spring-supported electropneumatic input valve (104) with at least two ports and being capable of switching between two positions, including an open position and a closed position, wherein the spring-supported electropneumatic input valve (104) is retained in the open position when there is no electronic activation of the spring-supported electropneumatic input valve (104), and wherein the spring-supported electropneumatic input valve (104) is connected to the manual brake pressure port (154) for receiving the driver's brake demand pressure component; and
a tractor protection module (124; 424) provided within the housing structure (100a) of the electropneumatic trailer control module (100).

2. The electropneumatic trailer control module (100) of claim 1, wherein the tractor protection module (124; 424) is positioned at a fluid path established between a connecting line leading from the outlet port (116) of the relay valve (112) and a control pressure coupling head (C1).

3. The electropneumatic trailer control module (100) of claim 1, further comprising a select-high valve (142), wherein the select-high valve (142) is configured to receive the pressure from two independent pressure sources (138, 140) and provide an output pressure component which is one of the two independent pressure sources (138, 140) and which has a higher magnitude of pressure in comparison to the other.

4. The electropneumatic trailer control module (100) of claim 3, wherein the output pressure component is connected to the supply port (114) of the relay valve (112) and, at the same time, forms the electropneumatic brake pressure component that reaches the electropneumatic brake pressure port (144; 146).

5. The electropneumatic trailer control module (100) of claim 1, wherein the electropneumatic trailer control module (100) further comprises an electropneumatic brake pressure inlet valve (108) that is electronically controlled and spring-supported, and wherein the electropneumatic brake pressure inlet valve (108) includes two ports (108.1, 108.2) and switches between two positions, including an open position and a closed position, and assumes the closed position as a default position.

6. The electropneumatic trailer control module (100) of claim 5, wherein the electropneumatic trailer control module (100) further comprises an exhaust solenoid valve (106) that is electronically controlled and spring-supported, wherein the exhaust solenoid valve (106) includes two ports (106.1, 106.2) and switches between two positions, including an open position and a closed position, and assumes the closed position as a default position, and wherein the exhaust solenoid valve (106) connects the pressure component at the control port (110) of the relay valve (112) to an exhaust or relief port (136) when the exhaust solenoid valve (106) is in the open position or is electronically energized.

7. The electropneumatic trailer control module (100) of claim 2, wherein the tractor protection module (124; 324) is configured to connect the fluid path leading to the control pressure coupling head (C1) with an exhaust path (136) when in a deactivated or closed state and to connect the outlet port (116) of the relay valve (112) to the control pressure coupling head (C1) when in an activated or open state.

8. The electropneumatic trailer control module (100) of claim 1, wherein the tractor protection module (124; 424) comprises a tractor protection control port (126) for receiving trailer brake pressure via a trailer brake pressure port (132).

9. The electropneumatic trailer control module (100) of claim 1, wherein the tractor protection module (124; 424) is a spring-supported pneumatically operated valve.

10. The electropneumatic trailer control module (100) of claim 8, wherein the tractor protection module (124; 424) includes
a control chamber (204; 404) for receiving the control pressure from the tractor protection control port (126);
a piston (216; 416) configured to linearly reciprocate on receiving the control pressure;
an intermediate supply chamber (222; 422) connected to the outlet port (116, 322) of the relay valve (112); and
an outlet chamber (224; 424) connected to an outlet line (134; 334), wherein the outlet line (134) leads to the control pressure coupling head (C1), and
wherein, when the control chamber (204; 404) receives the control pressure from the tractor protection control port (126), the piston (216; 416) is configured to linearly reciprocate such that a fluid connection between the intermediate supply chamber (222; 422) and the outlet chamber (224; 424) is established so that the pressurized fluid can reach the control pressure coupling head (C1).

11. The electropneumatic trailer control module (100) of claim 10, wherein the tractor protection module (124; 424) further comprises a spring (212) to bias the piston (216; 416) into a closed position such that, without the control pressure at the control chamber (204; 404), no fluid connection between the intermediate supply chamber (222; 422) and the outlet chamber (224; 424) can be or is allowed to be established.

12. The electropneumatic trailer control module (100) of claim 10, wherein the tractor protection module (124; 424) further includes a sealing element (220; 420) associated with the piston (216; 416) to sealingly separate the intermediate supply chamber (222; 422) from the outlet chamber (224; 424), when there is no control pressure received at the control chamber (204; 404).

13. The electropneumatic trailer control module (100) of claim 10, wherein the tractor protection module (124; 424) further comprises at least one tubular support member (208; 408) for aligning the piston (216; 416) in a linear position and/or for limiting misalignment of the piston (216; 416) in relation to the orientation of the tractor protection module (124; 424).

14. The electropneumatic trailer control module (100) of claim 1, wherein the tractor protection module (124; 424) is designed as a pneumatically operated valve with three ports (122, 120, 134) and one control port (126) and capable of being switched into two positions including an open position and a closed position.

15. The electropneumatic trailer control module (100) of claim 10, wherein the piston (216) includes a first slot (204d) comprising a sealing element (204c) for fluidically separating the outlet chamber (224) from an exhaust or relief port (136) when there is pressure in the control port (126) and/or the control chamber (204).

16. The electropneumatic trailer control module (100) of claim 10, wherein the tubular support (208) includes a slot (404d) comprising a sealing element (404c) for fluidically separating the outlet chamber (224) from an exhaust or relief port (136) when there is pressure in the control port (126) and/or the control chamber (404).

17. The electropneumatic trailer control module (100) of claim 10, wherein the piston (216) includes at least one leaking feature (280) to enable flow of pressurized fluid from the outlet chamber (224) towards an exhaust or relief port (136) when there is no pressure received in the control chamber (204).

18. The electropneumatic trailer control module (100) of claim 1, wherein the spring-supported electropneumatic input valve (104) comprises exactly two ports, including an input port and an output port (104.1, 104.2), and is configured to change between only two positions, including an open positon and a closed position, wherein the output port (104.2) is connected to the control port (110) of the relay valve (112).

19. The electropneumatic trailer control module of claim 13, wherein the tubular support member (208) further comprises a leaking feature in the form a gap (204b), wherein the gap (204b) enables connection between the existing space established between the piston (216) and the tubular support member (208) below the level of the gap (204b) and another chamber (204a).

20. The electropneumatic trailer control module of claim 3, wherein the select-high valve (142) is a double check valve.
